(19) United States
(12) Patent Application Publication
(10) Pub. No.: US 2024/0128592 A1
(43) Pub. Date: Apr. 18, 2024

(54) COMPLIANT PAD AND BATTERY PACK SYSTEM INCORPORATING THE SAME

(71) Applicant: Solid Power Operating, Inc., Louisville, CO (US)

(72) Inventor: Brandon KELLY, Longmont, CO (US)

(21) Appl. No.: 18/399,506

(22) Filed: Dec. 28, 2023

Related U.S. Application Data
(63) Continuation-in-part of application No. 18/199,038, filed on May 18, 2023.
(60) Provisional application No. 63/435,691, filed on Dec. 28, 2022.
(60) Provisional application No. 63/343,433, filed on May 18, 2022.

(51) Int. Cl. H01M 50/494; H01M 50/211; H01M 50/291; H01M 50/293

(52) U.S. Cl. CPC H01M 50/494; H01M 50/211; H01M 50/291; H01M 50/293; H01M 10/0525

(57) ABSTRACT

Aspects of the disclosure involve a compliant pad for distributing force and/or pressure to a battery or battery pack. Whether a single electrochemical cell or pack of cells, force may be applied to maintain pressure on the cell or cells from proper operation. The compliant pad may be used to evenly distribute the force on or among the cells. In addition or alternatively, the compliant pad may include thermal properties to transfer heat to or from the cells, and between cells.

### CROSS-REFERENCE TO RELATED APPLICATIONS

This application is related to and claims priority under 35 U.S.C. § 119(e) from U.S. Patent Application No. 63/435,691 filed Dec. 28, 2022, titled “Compliant Pad and Battery Pack System Incorporating the Same,” the entire contents of which is incorporated herein by reference for all purposes.

This application is also a Continuation-In-Part of U.S. Nonprovisional patent application Ser. No. 18/199,038 filed May 18, 2023, titled “Battery Pack System,” which claims the benefit of priority under 35 U.S.C. § 119(e) from U.S. Provisional Patent Application No. 63/343,433 filed May 18, 2022, titled “Battery Pack System,” both of which are hereby incorporated by reference in their entirety.

### TECHNICAL FIELD

Embodiments of the present invention generally relate to systems and methods for controlling force on battery cells to maintain proper operation of the same through charge and discharge cycles of the same; and more particularly to a compliant pad that may be positioned adjacent a battery cell or form part of a pack of cells to evenly distribute forces on the cell or cells among other benefits.

### BACKGROUND AND INTRODUCTION

Solid-state and other battery cells are often deployed in a pouch configuration. A solid-state battery cell is comprised of a layered structure that includes an anode and a cathode separated by a solid electrolyte. The layered structure is encased in a flexible aluminum or other laminate structure, which may be referred to as a pouch. Such a flexible pouch is used in some solid-state battery cells because the internal layered cell structure expands and contracts during charge and discharge, and the flexible pouch encasing the cell structure accommodates such expansion and contraction.

More particularly, referring to an example of a cathode material that is a lithium-containing compound, during charging, Li+ ions are extracted from the cathode and migrate to the anode by way of the solid electrolyte, and electrons transfer from the cathode to anode through whatever device is charging the battery. In contrast, during discharging, Li+ ions and electrons migrate and flow in the reverse direction, accompanied with cathode reduction, and anode oxidation. Electrons here flow through whatever device is being powered by the battery. A pouch casing is advantageous because the anode and cathodes expand and contract during charge and discharge albeit unequally. Namely, the anode expands disproportionally more than the cathode shrinks, resulting in a net positive expansion of a cell as the ions move from the cathode to the anode when charging. Conversely, the anode then shrinks disproportionally more than the cathode expands, resulting in a net negative shrinking of the cell when discharging.

Complicating the situation of cells differentially contracting and expanding, it is advantageous to apply pressure to the cell structure to enhance and maintain contact between the particles within various layers (e.g., particles of the anode, cathode and solid electrolyte), as well as enhance contact between the layers. Moreover, it may be important to manage the pressure so that it is evenly distributed as well as maintain the pressure at whatever the specified value for any particular battery cell type. Improper pressure management can lead to various problems including increased resistance, non-uniformities within the cell, capacity fade, decreased cycle life, dendrite growth and others.

It is with these observations in mind, among others, that various aspects of the present disclosure were conceived.

### SUMMARY

Aspects of the present disclosure involve a compliant pad that may be used in conjunction with a battery cell, and particularly a solid-state battery cell, to provide even pressure distribution across a surface of the battery cell and/or provide thermal distribution to the battery cell or cells. In a battery pack, such compliant pads may be positioned between battery cells forming the pack (e.g., between discrete pouched cells). Aspects of the present disclosure involve a battery force management system comprising a first battery cell stack, which battery cells may be solid-state battery cells and more particularly solid-state pouch cells, with compliant force distribution pads positioned between such solid-state cells, among other benefits. In some cases, the pack of cells, including the compliant pads, may be positioned between a first member and a second member where the first member and/or the second member are configured to apply or maintain a force on the cell stack and pads, and the pads even force distribution among the cells in the stack.

In one possible arrangement, a force management pad, sometimes referred to herein as a compliant pad, for a battery system comprises a first layer defining a first side and a second side, with a first compliant section operably coupled with the first side of the first layer. A second compliant section is operably coupled with the second side of the second layer. The force management pad is dimensioned to be placed between a first electrochemical cell (e.g., a solid-state electrochemical cell including a solid-state anode, solid-state cathode, and/or solid-state electrolyte) and a second electrochemical cell and distribute forces between the first electrochemical cell and the second electrochemical cell.

In an example, the first compliant section is as at least as thick as a dimension of a largest expected defect in an abutting surface of the first electrochemical cell. The first compliant section may include a reinforcement additive to reduce material flow of the first compliant section under the forces being distributed between the first electrochemical cell and the second electrochemical cell.

In another example, the first layer defines a first surface area and the first compliant section defines a second surface area where the first surface area is the same as the second surface area or larger than the second surface area. In another example, the first electrochemical cell is a pouch cell including an inner layered electrochemical structure, and the first surface area matches a surface area of the inner layered electrochemical structure. In other examples, a combination of the first compliant section and the second compliant section encapsulates the first layer. In still other examples, the first surface area does not expand laterally more than 1% of a length dimension of the first surface area

In some examples, the first layer is a thermally conductive metal. In specific examples, the first layer is a metal comprising copper, aluminum, or nickel. The first compliant layer may be silicone rubber, a Viton rubber, Buna-N, a natural rubber, a neoprene, or a polyurethane. The first compliant section may further include a low friction material, such as a coating, with a coefficient of friction of between 0.02 and 0.

In a solid-state battery pack comprising the cells and pads, the force management pad may distribute forces in the range of 50 PSI to 1500 PSI.

In specific dimensional arrangement examples, the inner layer defines a surface area at least as large as a first surface area of the first compliant layer facing the surface area of the inner layer, and the surface area is at least as large as a second surface area of the second compliant layer facing the surface area of the inner layer. In another example, the first compliant section defines a first continuous elastic resilient structure at a periphery of the first layer and the second compliant section defines a continuous elastic resilient structure at the periphery of the first layer.

A battery pack may include a first electrochemical cell (e.g., a first solid-state cell) and a second electrochemical cell (e.g., a second solid-state cell) with a first compliant pad, which may be of the form of the force management pad introduced above, positioned between and in contact with the first electrochemical cell and the second electrochemical cell. The compliant pad may include a first layer defining a first side and a second side, with a first compliant section operably coupled with the first side of the first layer and a second compliant section operably coupled with the second side of the second layer. The compliant pad may be dimensioned to be placed between a first electrochemical cell and a second electrochemical cell and distribute forces between the first electrochemical cell and the second electrochemical cell at least as the volumes of the first electrochemical cell and the second electrochemical cell expand and/or contract during charging and discharging.

These and other aspects of the present disclosure are described in further detail below.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale, may only include certain features representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is an isometric view of one possible example of a solid-state pouch cell.

FIG. 2A is a side view of one example of a solid-state pouch cell.

FIG. 2B is a side view of another example of a solid-state pouch cell.

FIG. 3A is a representative top view of a battery pack with cells and intervening compliant pads, the pack including translationally supported end plates, the end plates to maintain pressure on the cells.

FIG. 3B is a representative top view of the battery pack of FIG. 3A with the cells relatively more charged as compared to FIG. 3A.

FIG. 4A is an example of a compliant pad including an inner layer between opposing compliant layers, the inner layer and outer layers having the same width, in accordance with one embodiment of the present disclosure.

FIG. 4B is another example of a compliant pad including an inner layer between opposing compliant layers, the inner layer having a larger a length and a larger width dimension as comparted to the adjacent compliant layers, in accordance with one embodiment of the present disclosure.

FIG. 4C is another example of a compliant pad including an inner layer between opposing compliant layers where the inner and compliant layers define the same surface area, in accordance with one embodiment.

FIG. 5 is a side view of a pouch cell positioned between a first compliant pad and a second compliant pad, in accordance with one embodiment.

FIG. 6 is a front view of a first pouch cell and a second pouch cell including a first compliant pad section, a second compliant pad section, and a third compliant pad section alternatingly positioned relative to the pouch cells and with a continuous inner layer between the first, second and third compliant pad sections.

### DETAILED DESCRIPTION

Aspects of the present disclosure involve a compliant pad that may be positioned adjacent a pouch battery cell, and particularly a solid-state pouch cell, to evenly distribute forces on the pouch cell. Compliant pads may be positioned between pouch cells in a battery pack, and uniformly distribute forces among the pouch cells. Further, the compliant pad may have thermal properties to transfer heat to or from the pouch cells, and or distribute heat among the pouch cells. While the compliant pad is primarily described herein as being used in combination with solid-state pouch cells, it may be used in other applications such as hybrid solid-state pouch cells, liquid electrolyte cells, whether Li-Ion or otherwise, and other pouch cell types where pressure should be applied to the battery cell and/or would benefit from thermal management of the pouch cell. In some possible applications, the compliant pad may also be used with battery types not limited to pouched cells.

Aspects of the present disclosure further involve various systems and methods to monitor an apply pressure on a battery pack comprised of battery cells with compliant pads positioned adjacent and/or between the battery cells, which may be pouch type cells, and adjust the external force on the battery cells to maintain optimal pressure on and within the battery cells for optimal operation as a pack of such cells cycles between charged and discharged states, as well as maintaining proper pressure when the pack of cells is sitting in a state of equilibrium and not charging or discharging.

At a high level, it is advantageous to maintain even and proper pressure on some types of battery cells for optimal operation. Providing proper pressure is advantageous for a variety of battery cell types including hybrid solid/liquid cells, some liquid cells including those using lithium metal and silicon anodes, and solid-state battery cells. In various examples set out herein, solid-state battery cells may be referenced but it should be appreciated that aspects of the present disclosure are useful for various forms of rechargeable battery cells where proper pressure application is advantageous to the operation of the battery cell. In general, for a variety of battery cell types it is advantageous to maintain proper and relatively uniformly distributed contact of particles within the cell (e.g., particles forming the anode, cathode, and/or electrode) and between the various layers of any particular cell configuration. When appropriate contact and/or pressure is not maintained, there may be various possible problems including non-uniformities within or between layers of the cell and increased resistance, which can lead to various possible deleterious effects on the battery cell or the operation of the battery cell or a pack of such cells.

During fabrication of battery cells, there may be non-uniformities in the anode or cathode layers, or other features of the cell. While various techniques are used to minimize such non-uniformities wherever possible, normal manufacturing tolerances, material tolerances, and other factors introduce such non-uniformities. For example, anode or cathode layers may include non-uniformities on the surfaces of the layers and may include non-uniform material density within the layers. In some cases, non-uniformities may be a function of the shape or assembly of any given type of cell. For example, non-uniformities may exist along the edges of an anode or cathode layer and at the boundaries of such layers with an associated current collector. Additionally, non-uniformities may emerge in the presence of charge and discharge cycles, in the presence of heat, and through the application of pressure on the cells. Notably, non-uniformities may be present along the surface of the anode or cathode adjacent the pouch material and may thus be exposed through the pouch material.

As noted herein, to maintain proper operation of battery cells, it is often necessary or advantageous to apply external pressure on a battery cell. The compliant pad distributes such pressure more uniformly, particularly in the presence of non-uniformities in adjacent battery cells, as compared to applying the pressure directly to a cell, particularly by a rigid structure, or by disturbing such pressure from one battery cell to another directly.

As such, the various embodiments discussed herein monitor the external force on the cells and control the external force on the cells to provide optimal force on the same and pressure within the cells while accommodating the expansion of the cells during charge and the shrinking of the cells during discharge. Besides expansion and contraction from charge and discharge, other factors may, alone or in combination, may be a factor in altering force on a cell stack such as temperature, charge state, atmospheric pressure, and other factors. Various aspects of the present disclosure also may enhance the even distribution of force on the cells so that pressure and attendant particle contact within the cells, is relatively evenly distributed.

The term “battery” or “battery cell” in the art and herein can be used in various ways and may refer to an individual electrochemical cell having an anode and a cathode separated by an electrolyte, which may be a solid electrolyte, as well as a collection of such cells connected in various arrangements. For example, a solid-state electrolyte battery cell may include multiple anode and cathode layers, separated by solid electrolyte layers, which collection of anode, solid electrolyte, cathode layers may be encased within a flexible “pouch” that accommodates the expansion and contraction of the anode(s) and cathode(s) as the cell charges and discharges. Although many examples are discussed herein as applicable to a battery or a discrete cell, it should be appreciated that the systems and methods described may apply to many different types of batteries, battery chemistries, and may range from an individual cell to batteries involving different possible interconnections of cells such as cells coupled in parallel, series, and parallel and series. The various implementations discussed herein may also apply to different structural battery arrangements other than pouch cells and other cell structures that may accommodate size changes in the electrodes.

It should be noted that a pouch cell may include electrically conductive tabs that may connect to the electrode layers (e.g., anode and cathode layers) of the cell, typically at respective current collectors associated with the anode and cathode layers. Generally, in a pouch cell, there is a current collector for the anode layers and another current collector for the cathode layers. In some arrangements, there may be anode current collectors for each anode layer and cathode current collectors for each cathode layer, with the anode current collectors electrically coupled together and the cathode current collectors electrically coupled together. The current collectors provide an interface to the electrochemical cell (anode and cathode layers) where one conductive tab is electrically coupled with the anode current collector(s) and the other conductive tab is electrically coupled with the cathode current collector(s) such that the conductive tabs enable electrochemical energy to be transported from the cell to be used in other applications, such as in a product. Likewise, the system of current collectors, electrochemical cell, and conductive tabs enables energy to be transported into the electrochemical cell, such as when charging the electrochemical cell. The tabs may be connected to the electrode layers, e.g., the tab welded to a current collector of the cell, inside the sealed area of the pouch. The tabs may also extend beyond the outside of the pouch and may be used to connect the battery to an electric circuit, device, other batteries, and various combinations of the same in various possible embodiments.

The pouch may be made of flexible materials such as nylon, aluminum, and polypropylene or other materials suitable for encasing the cell. A pouch typically includes two sheets of layered material that are sealed together when pressure and heat is applied to the outer sections of the sheets, forming a pouch. In some examples, a single sheet of pouch material may be made up of 30-50 microns (μm) of nylon, 30-50 μm of aluminum, and 70-80 μm of polypropylene. In one specific example, a single pouch layer may include 40 μm of nylon, 40 μm of aluminum, and 80 μm of polypropylene. Non-uniformities in the anode or cathode layers can be reflected in the pouch sheets, particularly given the thinness of the pouch material. In one possible example, a first single sheet has an inner layer of aluminum sandwiched between one layer of nylon and one layer of polypropylene. In this example, a second single sheet including the same layers is used in combination with the first sheet to encapsulate the electrochemical cell and its components. The outer most layers of the pouch cell, which are the outer layers of each sheet, may be made of nylon. The next layer moving into the pouch cell, from any side, may be the aluminum layer. The two inner most layers of the flexible pouch material that physically come together to encapsulate the electrochemical cell and its components may be the polypropylene layers of each respective sheet.

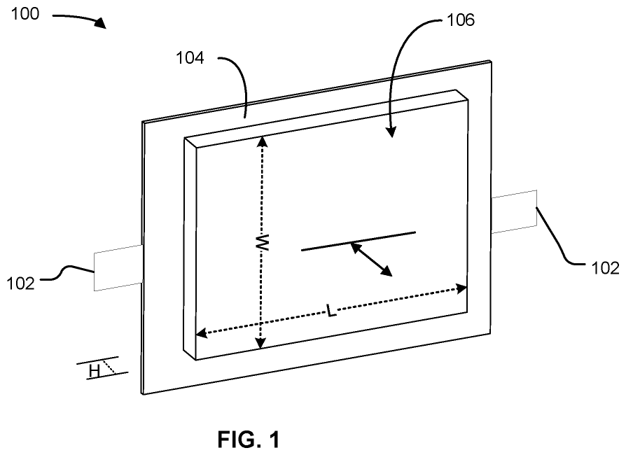

FIG. 1 is an isometric view of one possible example of a conventional pouch cell 100 formed of two sheets of layered material as discussed above. In this example, the pouch cell is generally rectangular in shape with conductive tabs 102 extending from opposing ends of the pouch cell. In many arrangements, a relatively flat sealed area 104, where the opposing sheets are sealed together, surrounds an electrochemical cell 106 inside the pouch bounded by the flat sealed area 104. Pouch cells may be of varying configurations including different shapes, such as the shape of a rectangle or square in possible examples. The electrochemical cell portion 106 has a width (W) and a length (L) defining a surface area of the cell portion, along with a height (H).

As introduced, the various compliant pads of the present disclosure are useful with a variety of different battery devices (e.g., electrochemical cell types) including various different types of solid-state, lithium-ion cells using liquid electrolyte, hybrid cells having a blend of solid and liquid electrolytes, or semi-solid cells. Generally speaking, each battery has some specified open circuit voltage and capacity (often specified in Ah (amp hour)). In a battery pack, discrete batteries (e.g., pouch cells) are interconnected in various possible series and parallel arrangements to provide the overall pack voltage, capacity, and charge/discharge current characteristics of the system the pack is powering. The battery tabs or other connections may be connected to respective power rails. Of note, tabs extending from the pouch cells of the present disclosure may not be illustrated in some views to not over complicate the views.

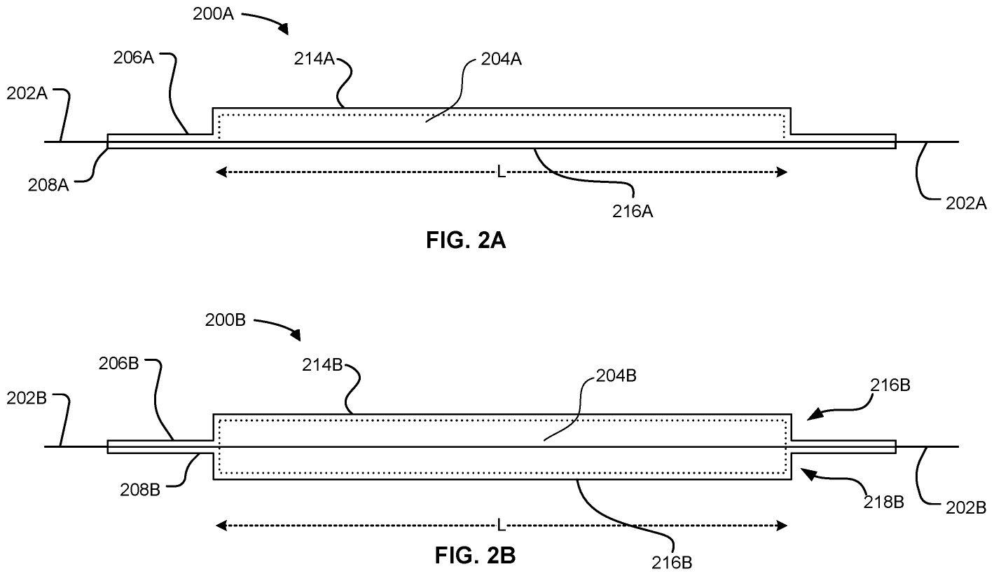

FIGS. 2A and 2B show two examples of a pouch cell 200A and 200B. FIG. 2A is a side view of the pouch cell depicted in FIG. 1. Referring to FIG. 2A, conductive tabs 202A extend beyond the layered pouch material at opposing ends of the pouch cell. A portion of the conductive tabs 202A may be sealed between sheets 206A and 208A of the pouch material (known as the sealed portion). The flexible pouch material, such as sheets 206A and 208A, encapsulate portions of the conductive tabs 202A as well as the layered electrochemical cell 204A and its components, such as the anode current collector(s) and the cathode current collector(s).

In the example of FIG. 2A, the lower sheet 208A is planar and the electrochemical cell structure 204A is on the sheet 208A and projects upward from the sheet 208A. Thus, the pouch cell includes a rectangular portion raised above the sealed boundary 104 where the raised rectangular portion encapsulates the cell structure. It should be noted that the top surface 214A, and similarly 214B, with respect to FIG. 2B, may include the entire top sheet 206A including the area of the flexible pouch material that extends beyond the edges of the electrochemical cell 204A.

Depicted in FIG. 2B, sheets 206B and 208B are formed over the cell structure 204B such that each includes a raised area, such as raised area 216B and 218B, at the internal cell structure 204B. In contrast, in FIG. 2A, the encapsulated cell defines a raised area 214A extending from a flat surface 216A. The two sheets (before being formed over the electrochemical cell to encapsulate the same) can have substantially the same dimensions or may have different dimensions respectively depending on the size and position of the electrochemical cell, components thereof, space of the battery pack or product, and various combinations of the same in various possible embodiments.

Referring to FIG. 1, as well as FIGS. 2A and 2B, the encapsulated cell has a width dimension (W) and a length dimension (L). As can be seen, the width and length of the encapsulated cell are less than the overall width and length of the pouch. It should be noted that although the length (L) is the longer dimension of the encapsulated cells shown, the length (L) and width (W) dimensions of the encapsulated cell can be any suitable dimension of the encapsulated cell, including equal dimensions, the length may be less than the width, the cell may not form a rectangle, for various possible pouch cells for use in battery packs or products in various possible embodiments of the present disclosure. When referring to the encapsulated cell dimensions, the dimensions should be considered to refer to the encapsulated cell but may also be considered to include the adjacent pouch material on the sidewalls as the pouch material is relatively thin and contributes minimally to the width and length dimensions.

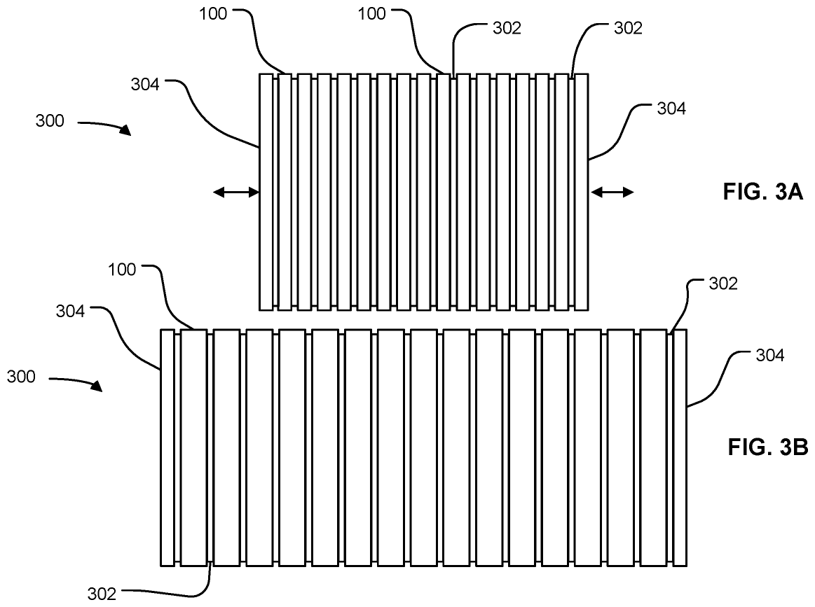

FIGS. 3A and 3B show a battery pack 300 comprising a collection of solid-state pouch cells 100 in a discharged state (FIG. 3A) and a charged state (FIG. 3B). As can be seen, the individual cells are expanded in the charged state relative to the discharged state. Complaint pads 302 are positioned between cells in the packs. In a pack, particularly one where a force plate or plates may be positioned at one or both ends of the stack of cells to apply force to the same, compliant pads may also be positioned at the ends of the stacks between the cells at the end of the stack and the force plate (not shown). While the compliant pads discussed herein are described primarily with regard to an embodiment with an inner layer and compliant sections on each face of the inner layer, a compliant pad used between a cell and a force member or other feature, movable or otherwise, at the outside end of the stack may only have compliant material on the face of the pad facing the cell. In such an example, the face of the pad facing the member may be bare or include some other material that is not necessarily compliant. In such an example, one side of the inner (first) layer of the compliant pad may be bare while the second side of the first layer would have the compliant material. The bare side would contact the member while the side with the compliant material would contact the cell. In such a configuration, the cell stacking dimension of the pack may be reduced by the thickness of two compliant layers of the pads at either end of the stack and adjacent a member (e.g., plate) at either end of the stack. The example cells referenced regarding FIGS. 3A and 3B are solid-state cells; however, the battery pack and integration of compliant pads is not limited to use with solid-state cells and may be used with a variety of cell types where it may be advantageous to provide a controlled force or maintained even pressure distribution across a cell or cells or between cells.

Note, the cells illustrated in the figures, including FIGS. 2A and 2B, are represented as planar rectangles in the various views but it should be noted that the wider area, such as area 204, is not shown to not overly complicate the figures. In a pack, the tabs of the various cells may be connected to respective power rails (not shown). Moreover, while power rails are referred to as being positioned along either side of the pack adjacent the tabs, power rails may be arranged in other positions and similarly tabs may extend from other parts of any particular type of cell. For example, rather than extending from opposite sides as shown in FIGS. 2A and 2B, tabs may extend from the same side of the cell.

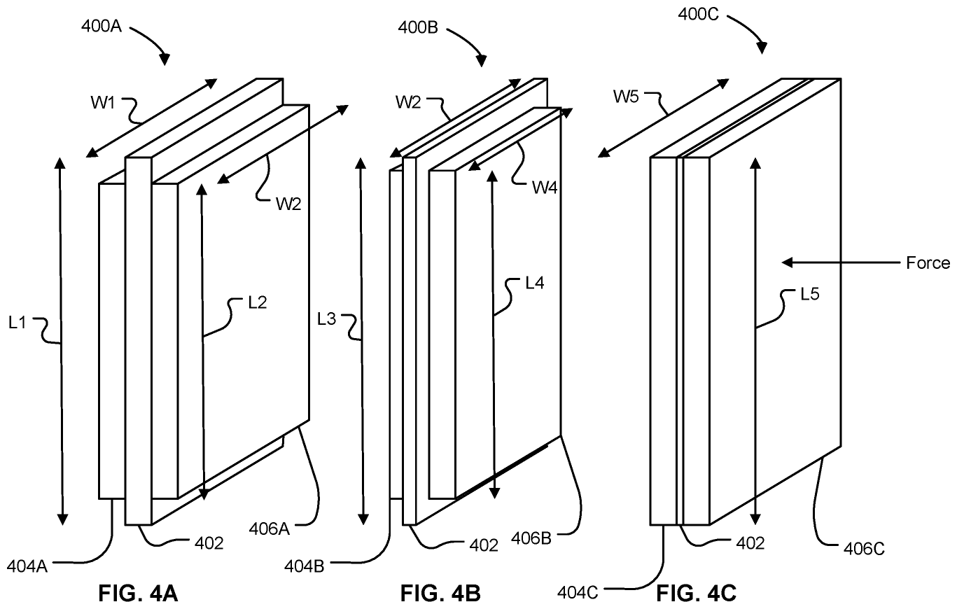

Turning now in more detail to the compliant pad, FIGS. 4A-4C illustrate perspective views of three examples of possible arrangements of a compliant pad 400A, 400B, and 400C consistent with the present disclosure. In common, each pad may include a first, or center, layer 402. Further, a pad may include one or more layers 404A-404C, 406A-406C, adjacent the center layer. In the examples shown, there is a center layer 402 with a second layer 404 (404A, 404B, and 404C, respectively) to one side of the respective center layer and a third layer 406 (406A, 406B, and 406C) to the other side of the respective center layer. Hence, the example pads each include three layers. In some examples, the compliant pad includes three or more layers selected from materials such that any given compliant pad facilitates uniform pressure distribution across the face of an electrochemical cell in a solid-state cell module stack without sacrificing uniformity.

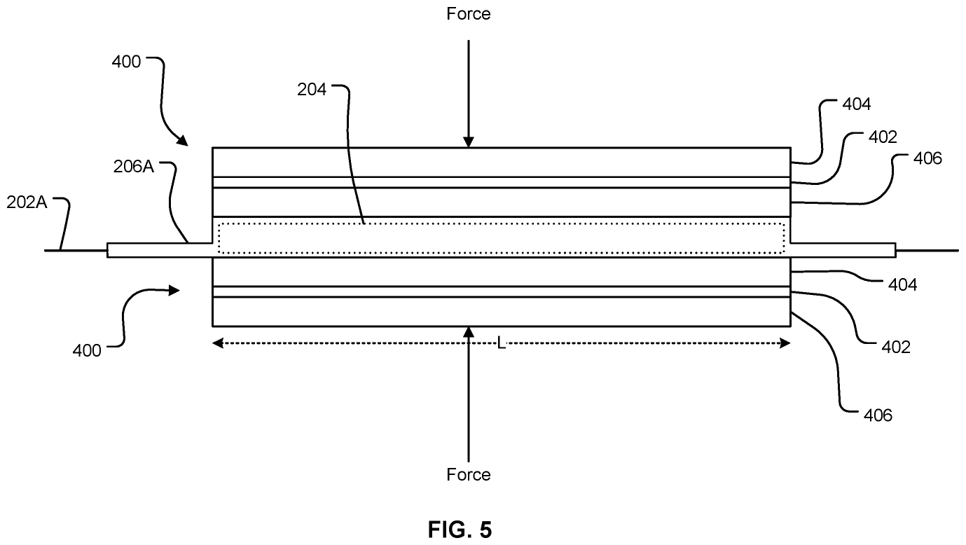

In the various possible examples set out herein, the first, or center layer 402 in some examples, is a sheet of laterally rigid material. The center layer resists stretching or extruding, laterally or planarly, under compressive forces that may be present when pressure is applied to a stack of cells including compliant pads. The compressive forces, as illustrated with respect to FIGS. 4C and 5 but applicable to the various embodiments, are applied generally perpendicularly to a plane defined by the center layer, and the center layer should maintain its lateral dimension in the presence of such forces. So, for example, the center layer should not expand laterally under compressive forces, e.g., 1500 psi or less, more than 1% of the lateral dimensions, and more preferably no more than 0.1%. It should be noted that the force is meant to be applied across the surface of the pad and/or raised portion of the cell structure (not only at one point) of the pouch cell such that force is applied as uniformly as possible across the layers of the cells.

As noted, the pads illustrated in FIGS. 4A, 4B and 4C each include an inner layer along with opposing second and third (outer) compliant layers. As will be discussed in further detail below, the outer layers may be compliant. In the various examples, there may be differences between the outer (e.g., length and width) dimensional relationships between the respective outer compliant layers and the associated inner layer. Referring specifically to FIG. 4A, the inner layer 402 defines a rectangle with a length L1 and a width W1. The opposing and adjacent compliant layers 404A, 406A define a rectangle with a length L2 and a width W2. In this example, the length L1 is greater than the lengths L2, whereas the width W1 is the same as the width W2. As such, the inner layer is longer in one dimension than the adjacent compliant layers and in another dimension, the same size. The two compliant layers have the same width W2 and length L2 dimensions. Referring to FIG. 4B, the inner layer 402 defines a rectangle with a length L3 and a width W3. The outer compliant layers 404B, 406B define a rectangle with a length L4 and a width W4. In this example, the length L3 is greater than the lengths L4 and the width W3 is also greater than the width W4. As such, the inner layer is longer in both the length and width dimensions as compared to the adjacent compliant layers. The embodiment of FIG. 4B may be particularly useful in a pack configuration where precise temperature control of the cells is important. The two (outer) compliant layers have the same width W4 and length L4 dimensions. In both the examples of FIGS. 4A and 4B, the surface area of the plane defined by the inner layer is larger than the surface area defined by the plane of the adjacent compliant layers.

In contrast and referring to FIG. 4C, here the compliant layers 404C, 406C and the inner layer 402 have the same length L5 and width W5 dimensions. In FIG. 4C, the inner layer is exposed between the compliant layers around its periphery. It is also possible to completely coat the inner layer, including the periphery, with a compliant material.

In some examples, the center layer 402 may be a thin film or sheet, and may be metal-based such as copper, aluminum, or nickel or some alloy thereof. In various possible examples of using an aluminum foil as the center/inner layer, the foil may have a thickness in the range of 0.018-0.2 mm. In another range of examples, the center layer may have a thickness in the range of 0.010-0.3 mm. When the center layer is a metal or other thermally conductive material, the center layer and the outer pad (or opposing pads) can aid in the distribution of heat to or from an adjacent cell or cells, within such cells, and/or between such cells. In another example, the center layer may be a thin sheet of a light-weight material such as a ridged polymer or carbon fiber sheet. In examples, the metal or non-metal sheet may be considered a substrate upon which the compliant layers (e.g., pad or pads) are applied or otherwise affixed. In yet another example, the center layer may be comprised of a combination of a thermally conductive material, such as a metal sheet or sheets, on a ridged polymer substrate. In such an example, the center layer of the compliant pad is composed of more than one layer, such as two layers. Such an arrangement may provide thermal control but reduce the overall weight as compared to a metal sheet without a substrate. In another example, the center layer may be composed of an inner rigid substrate with opposing metal foils laminated or otherwise formed on the inner substrate. In such an example, the center layer may be composed of three layers. Different possible polymers may be used in various possible applications with the polymer selected such that it will not planarly deform, stretch, or extrude outward past a boundary of an adjacent cell or cells when under a large compressive force.

In the various example of a thermally conductive center layer, various embodiments may further include a thermal connection (or connections) to the center layer. As such, the center layer may be used to transfer heat to or from the compliant pad and any adjacent cells For example, for battery types that operate optimally in some temperature window, it is possible to couple a thermally conductive bus bar or some other form of thermal transfer medium to the center layers of the compliant pads to transfer heat to or from the cells to either heat the cells or cool the cells, or distribute heat between cells. In turn, some form of temperature management device may be coupled to the bus bar or other medium to heat or cool the bus bar, which heating or cooling is in thermal communication with the cells. The use of a compliant pad to transfer thermal energy to and from a cell is particularly advantageous in a battery pack where cells are stacked, and external thermal transfer is unevenly applied to the exposed outer areas versus the inner areas of the cells in some convention environments that manage the temperature in the external environment surrounding a pack. Stated differently, use of the compliant pad to further manage thermal properties of a stack of cells may assist in uniform thermal distribution to the cells, which has various attendant benefits including relatively more uniform aging in a pack, reducing thermal discontinuities in cells, which may affect dendrite growth, maximizing charge capacity, and other benefits.

In addition to the inner layer (or layers), a compliant pad further includes at least one of a second layer and a third layer, which may also be referred to as a compliant layer or layers. In some specific examples, such as illustrated in FIGS. 4A-4C, a compliant pad includes compliant layers 404, 406 on each side of the center layer 402. In one example, the compliant layer is a soft resilient polymer material adhered to the center layer. As such, the compliant layer compresses under load and distributes forces across the surface of the electrochemical cell. When the load is removed, the compliant layer returns to its original shape. In various possible examples, the compliant pad may cycle returning to its original shape no less than 1000 cycles. The soft resilient polymer material may be laminated, spray coated, vulcanized, etc., onto the center layer, in various possible examples. The polymer of the compliant layer (or layers) may be a “soft” low durometer material. In various possible examples, the soft polymer of the compliant layer may be made of one or more of a silicone rubber, Viton rubber, Buna-N, natural rubber, neoprene, or polyurethane.

The compliant layers should be relatively thin. For example, the thickness of the compliant layer should be selected such that it is at least as thick as a height of largest defect expected to be found on a surface of the electrochemical cell. In another example, the compliant layer should be at least as thick as the height of any defect after presentation by the pouch material. So, in one example, if a cell has a surface defect and/or overall roughness with one or more features that are 5 microns high or deep, the polymer layer should be at least 5 microns thick. The term defect refers to surface defects, roughness, variations in thickness of the cell, among other things, which may be accommodated by the compliant layer or more generally the compliant pad. In some cases, the layer may have a thickness 10%-100% greater than that of the largest surface defect found, or expected to be found, on the electrochemical cell. Unlike the center layer, the compliant layers may deform laterally in the presence of large compressive forces. As such, if a thickness of the compliant layer polymer layer is too large, it may deform or extrude past the edges of the electrochemical cells when under large compressive forces which may cause pressure distribution nonuniformities at the edges of the adjacent cell or cells. It is also advantageous to define the compliant layers to have a minimal or no insulating effect to facilitate heat distribution through the compliant layers. In various possible examples, the compliant layers have a thickness between 5 and 20 microns.

In possible examples, any given compliant layer may be comprised of more than one layer of different materials to give the compliant layer, as a whole, optimal properties such that is may function in a temperature window of −10° C. to 70° C. and a pressure window between 50 psi and 1500 psi, in various possible ranges of operation depending, at least in part, on the type of cell, the environment in which a pack of cells is deployed, and/or the way of pressure/force management on the pack.

In yet another example, the compliant layer may have thermally conductive properties to aid in heat distribution, alone or in combination with the center layer. In one example, a soft polymer compliant layer material may incorporate carbon or other thermally conductive particles or more generally material.

In various possible examples, the stiffness of a compliant layer may be modified by incorporating a reinforcement additive (or additives) to alter the mechanical properties of the compliant layer. One of the functions of the additive is to add structural support to a material that may flow under pressure. While some flow is expected and will not affect performance, in instances where too much flow is experienced, the reinforcement additives may allow some flow at the surface, filling in irregularities and the like, but the bulk is rigid enough to prevent too much flow and displacement. The reinforcement additives may be metal fibers (Al, Cu, Ni, etc.), Carbon Fibers, natural fibers, and fibers made of the material of the center layer, among other possibilities.

Alignment features may also be added, such as holes in the corner to aid in assembly or alignment to the module. Such holes may aid in assembly, such as by placing a member through an alignment of such holes in a pack configuration, where the member (e.g., rod or the like) is removed after assembly. It is also possible to include a protruding surface or surfaces along an edge or edges, in a corner or corners, or other location that is adapted the shape and/or dimension for the type of cell, e.g., pouch cell, that the compliant pad will be used with and where the protruding surface etc. assists in locating the pad relative to an adjacent pouch cell. After assembly, pack pressure will be sufficient to maintain alignment of the various cell, pad, cell, etc., arrangements. Although primarily considered for assembly, a member of some sort may remain in the alignment holes after assembly.

A low friction material, such as Teflon, may be coated onto the outermost surface of the compliant layer or layers. In various examples, a low friction material may have a coefficient of friction of between 0.02 and 0.2. This may allow the compliant layer to more easily flow into/around defects without pulling/pushing on the pouch material used to protect the electrochemical cells. Besides Teflon, the compliant layer (or layers) may have a polyimide, PEEK (polyetheretherketone), PPS (Polyphenylene Sulfide), Nylon, Acetal and/or Polyester coating.

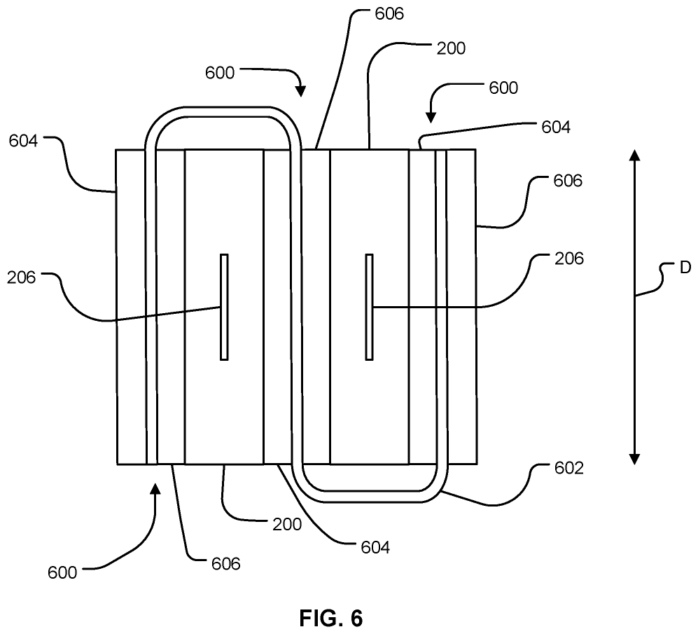

Referring to FIG. 6, a compliant pad may be considered continuous as opposed to discrete pads. In this example, the center layer 602 to be a continuous metal film that weaves its way around each cell 200 where the soft polymer layer (layers) 604, 606 are coated on the specific areas of the center layer where the central layer would contact the electrochemical cells. The portions of the center layer between cells may be exposed, e.g., not coated. In this example, compliant sections are coated onto or otherwise adhered to the center layer at regular intervals. For example, referring in more detail to FIG. 6, a plurality of compliant pad sections 600 are interconnected by way of a common center layer substrate 602. Each section comprises a first compliant portion or section 604 and a second compliant section or portion 606. In manufacturing, these sections are equidistantly spaced and dimensioned consistent with the type of cell and dimension of cell in which they will be used. In this example, the cells 200 have the same dimension (D), e.g., width, as the compliant sections. When assembled, the common center layer 602 extends outward from the sides of the pads 90 degrees with regard to the sides of the cell from which the tabs 206 extend (the tabs are extending out of the page in the example of FIG. 6).

In FIG. 6, the common center layer remains in the assembled pack. In such a case, the exposed portion of the center layer should be flexible and of sufficient length and, between cells, to expand and contract (accordion) with the cells during charge and discharge. Alternatively, after coating or otherwise coupling the compliant portions to the center layer, the center layer may be trimmed along the edges of the compliant sections thereby forming discrete compliant pads. This may be done before assembly into a pack or after assembly. If trimmed, the center layer may be trimmed immediately at the edges of the compliant layers or a center layer portion may extend outwardly from the compliant sections such as shown in FIG. 4A or 4B, in which cases the remaining exposed center layer portions may be coupled with a thermal transfer medium.

In a pack arrangement and referring back to FIGS. 3A and 3B, the cells 100 and intervening compliant pads 302 may be positioned between end plates 304, one or both of which may be controllably movable to maintain force on the stack of cells or may include a spring or springs (not shown) that maintain pressure on the stack of cells as the cells cycle between charge and discharge states and attendant size changes. The end plates, shown in section, may be planar along the face that would engage an adjacent cell 100 or compliant pad 302. In alternative examples, particularly in configurations that may experience wide pressure ranges and high pressures, e.g., 50 PSI to 1500 PSI, the end plates may include reinforcing structures, along the surfaces or otherwise not engaging the pad or cell, to prevent or eliminate bending or other deformation. In other examples, the end plates may define some preset counter curve that deforms and flattens into a planar orientation under the stack pressure forces applied in by the system. In one example, one or both end plates may be box end plates. The end plates, or more generally retaining members, capture the collection of cells and maintain force (pressure) on the collection of the cells by being moved inwardly toward each other as the cells are discharged and their volumes are decreasing (e.g., shown in FIG. 3A) or by being moved outward away from each other as the cells are charged and their volumes are increasing (e.g., shown in FIG. 3B). In essence, the collection of cells between the plates are squeezed by and between the end plates at a force, which may be mechanical such as through springs and/or controlled, to maintain the appropriate force on the cells while they are expanding and contracting during charging and discharging cycles. The end plates, generally, maintain consistent pressure across the facing surface of the cells, in the different states of expansion and contraction, and the compliant pads between the cells facilitate evenly distributing the pressure on and between the cells.

FIG. 5 illustrates one example of an arrangement of two compliant pads 400 on either side of a cell 200. In this case, the cell is like that shown in FIG. 2A and the pad is like that shown in FIG. 4C, but other combinations of cell types and pads are possible. The arrangement shown in FIG. 5 may be used in a pack like shown in FIGS. 3A and 3B, or may be used with a single cell where pressure applied with plates or otherwise to the cell by way of the compliant pads.

To maintain relatively even force (pressure) on the cells as applied by the end plates, the end plates are arranged and maintained in parallel to each other and the pouches are arranged such that the relatively planar portions of the cells facing the respective end plates are also generally parallel to each other and the end plates. Similarly, the planar portions of the compliant pads are positioned parallel with the cells, and in an arrangement with plates, also parallel to the plates. As such, the respective planes of the plates facing inwardly toward the cells and immediately adjacent pad are parallel, and that parallel orientation is maintained as the plate (or plates) are moved inwardly and outwardly, and the parallel planar maintenance maintains even pressure distribution on the cells in coordination with the compliant pads.

In the various embodiments, the system may further comprise some form of load measuring system such as a load cell or load cells, strain gauge or strain gauges, or other mechanisms by which the force being applied by the end plates on the captured cells may be measured and form part of a feedback loop by which the various drive mechanisms are controlled to adjust the position of the plates. While the term force is used herein to describe the various load measuring arrangements, the term is meant to also encompass other possible measurements including torque and pressure. As such, other sensors may be used such as pressure sensors. Further, force may be measured or derived from other measurements. Force may also be a computed through measurement of position, derived from motor control measurements, plate position, derived from motor position, and the like. It is also possible to characterize a battery system sufficiently that state of charge, temperature, and other factors may be used to determine the position of a plate to provide the necessary force on the pouches to provide optimal operation. In the various possibilities, the plate position or plate positions, relative to one another, is based on the compressive force being applied to the cell stack between the plates.

Embodiments of the present disclosure include various operations, which also may be referred to as steps, which are described in this specification. The operations may be performed by hardware components or may be embodied in machine-executable instructions, which may be used to cause a general-purpose or special-purpose processor programmed with the instructions to perform the operations. Alternatively, the operations may be performed by a combination of hardware, software and/or firmware.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together and in various possible combinations of various different features of different embodiments combined to form yet additional alternative embodiments, with all equivalents thereof.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the various embodiments for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

What is claimed:

1. A force management pad for a battery system comprising:
a first layer defining a first side and a second side;
a first compliant section operably coupled with the first side of the first layer; and
a second compliant section operably coupled with the second side of the first layer; wherein the force management pad is dimensioned to be placed between a first electrochemical cell and a second electrochemical cell and distribute forces between the first electrochemical cell and the second electrochemical cell.

2. The force management pad of claim 1 wherein the first compliant section is at least as thick as a dimension of a largest expected defect in an abutting surface of the first electrochemical cell.

3. The force management pad of claim 1 wherein:
the first layer defines a first surface area; and
the first compliant section defines a second surface area;
wherein the first surface area is the same as the second surface area or larger than the second surface area.

4. The force management pad of claim 3 wherein the first electrochemical cell is a pouch cell including an inner layered electrochemical structure, and wherein the first surface area matches a surface area of the inner layered electrochemical structure.

5. The force management pad of claim 4 wherein the inner layered electrochemical structure comprises a solid-state anode and a solid-state cathode.

6. The force management pad of claim 5 wherein the inner layered electrochemical structure further comprises a solid-state electrolyte.

7. The force management pad of claim 1 wherein a combination of the first compliant section and the second compliant section encapsulates the first layer.

8. The force management pad of claim 1 wherein the first layer is a thermally conductive metal.

9. The force management pad of claim 3 wherein the first surface area does not expand laterally more than 1% of a length dimension of the first surface area.

10. The force management pad of claim 1 wherein the first layer is a metal comprising copper, aluminum, nickel, stainless steel or alloys thereof.

11. The force management pad of claim 1 wherein the first compliant layer is a silicone rubber, a Viton rubber, a Buna-N, a natural rubber, a neoprene, or a polyurethane.

13. The force management pad of claim 1 wherein the pressures being distributed are in the range of 50 PSI to 1500 PSI.

14. The force management pad of claim 1 wherein the first compliant section includes a low friction material with a coefficient of friction of between 0.02 and 0.2.

15. The force management pad of claim 1 wherein the first layer defines a surface area at least as large as a first surface area of the first compliant layer facing the surface area of the first layer, and the surface area is at least as large as a second surface area of the second compliant layer facing the surface area of the first layer.

16. The force management pad of claim 1 wherein the first compliant section defines a first continuous elastic resilient structure at a periphery of the first layer and the second compliant section defines a continuous elastic resilient structure at the periphery of the first layer.

17. The force management pad of claim 1 wherein the first compliant section comprises a reinforcement additive to reduce material flow of the first compliant section under the forces being distributed between the first electrochemical cell and the second electrochemical cell.

18. A battery pack comprising:
a first electrochemical cell;
a second electrochemical cell; and
a first compliant pad positioned between and in contact with the first electrochemical cell and the second electrochemical cell, the first compliant pad comprising:
a first layer defining a first side and a second side;
a first compliant section operably coupled with the first side of the first layer; and
a second compliant section operably coupled with the second side of the second first; wherein the first compliant pad is dimensioned to be placed between a first electrochemical cell and a second electrochemical cell and distribute pressure between the first electrochemical cell and the second electrochemical cell as the volumes of the first electrochemical cell and the second electrochemical cell expand and/or contract during charging and discharging.

19. The battery pack of claim 18 wherein:
the first electrochemical cell, the first compliant pad, and the second electrochemical cell positioned between a first member and a second member, the first member movably mounted and arranged to apply a force thereon.

20. The battery pack of claim 19 further comprising a second compliant pad positioned between the first member and the first electrochemical cell.

21. The battery pack of claim 20 wherein the second compliant pad comprises a second layer defining a third side and a fourth side, and a third compliant section operably coupled with the third side facing the first electrochemical cell.

22. The battery pack of claim 19 further comprising a second compliant pad positioned between the second member and the second electrochemical cell.

23. The battery pack of claim 18 further comprising a second compliant pad between and in contact with the second electrochemical cell and a third electrochemical cell, the second compliant pad including the first layer of the first compliant pad and defining the first side and the second side, the first layer defining a continuous layer between the first compliant pad and the second compliant pad, the second compliant pad further including a third compliant section operably coupled with the first side of the first layer and a fourth compliant section operably coupled with the second side of the first layer, wherein the first compliant section and the second compliant section of the first compliant pad are dimensioned based on a dimension of first electrochemical cell and a dimension of the second electrochemical cell and the third compliant section and the fourth compliant section are dimensioned based on the dimension of the second electrochemical cell and a dimension of the third electrochemical cell.

24. The battery pack of claim 18 wherein the first electrochemical cell comprises a first solid-state pouch cell and the second electrochemical cell comprises a second solid-state pouch cell.
